(19) United States
(12) Patent Application Publication
(10) Pub. No.: US 2026/0107084 A1
(43) Pub. Date: Apr. 16, 2026

(54) DUAL-OPPOSED INVERTED TRANSDUCER ASSEMBLY

(71) Applicant: ALPS ALPINE CO., LTD., TOKYO (JP)

(72) Inventor: Rory Buszka, Novi, MI (US)

(21) Appl. No.: 18/917,404

(22) Filed: Oct. 16, 2024

(51) Int. Cl. H04R 1/24; H04R 1/02; H04R 7/12; H04R 9/02; H04R 9/04; H04R 9/06

(52) U.S. Cl. CPC H04R 1/24; H04R 1/025; H04R 7/12; H04R 9/025; H04R 9/046; H04R 9/06; H04R 2400/11; H04R 2499/13

(57) ABSTRACT

A transducer assembly with two active acoustic radiators. The two active acoustic radiators can face each other and be driven with signals having the same electrical polarity. The moveable features of the two active acoustic radiators can move toward and away from each other as the two active acoustic radiators are driven, which can reduce reaction forces transferred to an interior trim of a vehicle to decrease vibration thereof. The two active acoustic radiators can include an inverted topology with the motor assemblies disposed on a front side of the diaphragms of the two active acoustic radiators opposite rear suspension elements, which can efficiently utilize an existing packaging envelope of a conventional acoustic radiator to provide an equivalent combined piston area as the conventional acoustic radiator. A structural member can mechanically couple the motor assemblies in opposition to each other to provide improved force canceling characteristics.

### FIELD

The present disclosure relates in some aspects to transducers, including dual-opposed or force-canceling transducer assemblies for loudspeakers.

### BACKGROUND

Conventional loudspeakers produce a reaction force proportional to a moving mass and acceleration, opposite a direction of travel of a cone of the conventional loudspeaker. With a conventional loudspeaker mechanically coupled to a massive structure, the reaction force is absorbed by the massive structure, but with the mass of the structure reduced, the available mass to sink the reaction force is also reduced, resulting in unwanted vibration.

### SUMMARY

Modern vehicles continue to employ lighter components for increased speed and/or fuel economy, as well as reduced manufacturing cost. For example, the interior trim of a vehicle (e.g., interior trim of a door, interior trim of a dashboard, etc.) can be made of a relatively light material, such as a polymer (e.g., plastic, polyvinyl chloride, acrylonitrile butadiene styrene, polycarbonate, etc.) and/or other materials. Loudspeakers can be installed within the interior of a vehicle by coupling the loudspeakers to the interior trim. However, the available mass of the interior trim to absorb reactionary forces produced by the loudspeakers can be limited due to the light materials of the interior trim. With less available mass to sink the vibration, buzz, squeak, and rattle issues, which are commonly referred to as BSR issues (e.g., distortion issues), can occur as the interior trim vibrates, rattles, shakes, etc. Attempts to cancel out reaction forces to reduce BSR issues have been made by employing dual-opposed loudspeakers (e.g., U.S. Pub. No. 2019/0037295) but such arrangements have inefficiently used space such that radiating areas are reduced, which require longer excursions of the loudspeakers to move the same air volume as a conventional speaker.

The transducer assemblies described herein can address one or more of the above-identified problems. The transducer assemblies can include two active acoustic radiators that can be driven with signals having the same electrical polarity. The two active acoustic radiators can oppose each other (e.g., face each other) such that the moving assemblies (e.g., voice coils, diaphragms) move toward each other or away from each other to create substantially equal and opposing reaction forces about an axial center as the two acoustic radiators are driven, which can reduce vibration energy transferred from the two active acoustic radiators to a mounting substrate (e.g., interior trim of a vehicle) to reduce and/or eliminate BSR issues. The opposing arrangement of the two active acoustic radiators can result in cancellation or reduction of the force in a normal direction to a mounting plane of the transducer assembly, which can reduce vibration energy transmitted to the mounting substrate (e.g., reduce vibration directly transmitted from a fame of the transducer assembly to the mounting substrate). The reduction and/or elimination of BSR issues can improve the listening experience within a cabin environment.

While arrangements of opposing transducers for vibration cancellation have been previously known in the art, the use of available space in their implementation has heretofore been inefficient. The present invention inverts the topology of the two active acoustic radiators to more efficiently utilize space (e.g., reduce overall internal depth required for each active acoustic radiator) compared to conventional topology. For example, inverting the topology of the two active acoustic radiators can permit more cone area compared with conventional topology such that a swept air volume of the two active acoustic radiators can be equal to a conventional active acoustic radiator with a same amount of linear piston travel. The two active acoustic radiators can have a combined piston area that is the same as a conventional active acoustic radiator that is being replaced. The inverted topologies of the active acoustic radiators can enable the transducer assembly to operate with lower distortion compared to conventional topology. The inverted topologies of the active acoustic radiators can enable the transducer assembly to displace more air with reduced overall material cost compared to conventional topology active acoustic radiators. The motor assemblies (e.g., fixed or permanent magnet, components to conduct magnetic flux to an air gap, voice coil, and/or former element) of the two active acoustic radiators can be disposed on a front side (e.g., within a void of a cone-shaped diaphragm) of the corresponding diaphragm to efficiently use space, which can decrease the axial heights of the two active acoustic radiators. When the radiators are configured to displace air within a slot or duct, centralizing the motor assemblies within the slot of the transducer assembly (e.g., positioning the motor assemblies between the diaphragms of the two active acoustic radiators) can permit the slot opening to be larger, which can provide better airflow and less unwanted resonant effect of the slot. The motor assemblies can be disposed on front sides of the diaphragms that are opposite from rear suspension elements (e.g., spiders).

Centralizing the motor assemblies can enable the motor assemblies and/or supporting structures thereof to be mechanically coupled together, which can provide improved force canceling characteristics. In some variants, the motor assemblies can be physically coupled together. For example, a structural member can be disposed between the two active acoustic radiators and couple them together. The structural member can be coupled to a frame of the transducer assembly and/or directly to a mounting substrate. Conducting reaction forces from the active acoustic radiators in opposing directions along a common or parallel axis into a common structural member, which can be part of a frame of the transducer assembly, can produce more effective reaction force cancellation or reduction between the motor assemblies, which can reduce the transmission of force to the mounting substrate (e.g., interior trim of the vehicle) and/or reduce the distortion caused by flexing of the frame of the transducer assembly. In some variants, the axes of the two active acoustic radiators (e.g., axes of the voice coils of the two active acoustic radiators) can be coaxially positioned, parallel, and/or angled relative to each other. In some other variants, multiple pairs of acoustic radiators so positioned can be used to obtain even more diaphragm area without increasing the physical depth of the assembly.

Various transducer assemblies are disclosed herein. A transducer assembly, which can be for a vehicle, can include a frame that can be incorporated into an interior trim of a vehicle. The transducer assembly can include a first active acoustic radiator disposed in the frame. The first active acoustic radiator can include a first movable diaphragm, a first rear suspension, and/or a first motor assembly. The first motor assembly can include a first magnetic circuit and a first voice coil. The first motor assembly can be disposed at a front side of the first movable diaphragm. The first rear suspension can be disposed at an opposite rear side of the first movable diaphragm. The transducer assembly can include a second active acoustic radiator disposed in the frame. The second active acoustic radiator can include a second movable diaphragm, a second rear suspension, and/or a second motor assembly. The second motor assembly can include a second magnetic circuit and a second voice coil. The second motor assembly can be disposed at a front side of the second movable diaphragm. The second rear suspension can be disposed at an opposite rear side of the second movable diaphragm. The transducer assembly can include a structural member disposed between the first active acoustic radiator and the second active acoustic radiator. The structural member can receive the first motor assembly and the second motor assembly. The first motor assembly and the second motor assembly can be disposed between the first movable diaphragm and the second movable diaphragm. The first voice coil and the second voice coil can move toward each other and away from each other with the first active acoustic radiator and the second active acoustic radiator driven with signals having a same electrical polarity such that a resultant reaction force is reduced about an axial center.

In some variants, the transducer assembly can include a front structural member connected to and extending between the first active acoustic radiator and the second active acoustic radiator.

In some variants, the structural member can couple the first motor assembly and the second motor assembly.

In some variants, the first motor assembly and the second motor assembly can be coaxially positioned.

In some variants, the first movable diaphragm and the second movable diaphragm can each include a cone shape. The first motor assembly can be at least partially disposed in a void of the cone shape of the first movable diaphragm. The second motor assembly can be at least partially disposed in a void of the cone shape of the second movable diaphragm.

In some variants, the frame can include an enclosed air volume.

In some variants, the structural member can be coupled to a wall of the vehicle.

A transducer assembly can include a frame. The frame can include an interior fluid volume or plenum. The transducer assembly can include a first active acoustic radiator disposed in the interior fluid volume or plenum. The first active acoustic radiator can include a first movable diaphragm, a first rear suspension, and/or a first motor assembly. The first motor assembly can include a first magnetic circuit and a first voice coil. The first rear suspension and the first motor assembly can be disposed on opposite sides of the first movable diaphragm. The transducer assembly can include a second active acoustic radiator. The second active acoustic radiator can be disposed in the interior fluid volume or plenum. The second active acoustic radiator can include a second movable diaphragm, a second rear suspension, and/or a second motor assembly. The second motor assembly can include a second magnetic circuit and a second voice coil. The second rear suspension and the second motor assembly can be disposed on opposite sides of the second movable diaphragm. The first voice coil and the second voice coil can move toward each other and away from each other with the first active acoustic radiator and the second active acoustic radiator driven with signals having a same electrical polarity.

In some variants, the transducer assembly can include a structural member disposed between the first active acoustic radiator and the second active acoustic radiator. The structural member can receive the first motor assembly and the second motor assembly.

In some variants, the transducer assembly can include a first structural member and a second structural member. The first structural member and the second structural member can be disposed between the first active acoustic radiator and the second active acoustic radiator. The first structural member can receive the first motor assembly. The second structural member can receive the second motor assembly.

In some variants, a first central axis of the first motor assembly and a second central axis of the second motor assembly can be coaxially positioned.

In some variants, a first central axis of the first motor assembly and a second central axis of the second motor assembly can be parallel.

In some variants, a first central axis of the first motor assembly and a second central axis of the second motor assembly can be angled relative to each other.

In some variants, the first movable diaphragm and the second movable diaphragm can each include a cone shape. The first motor assembly can be at least partially disposed in a void of the cone shape of the first movable diaphragm. The second motor assembly can be at least partially disposed in a void of the cone shape of the second movable diaphragm.

A transducer assembly can include a frame. The transducer assembly can include a motor assembly including a magnetic circuit assembly. The magnetic circuit assembly can include a first portion with a first voice coil and a second portion with a second voice coil. The transducer assembly can include a first active acoustic radiator supported by the frame. The first active acoustic radiator can include a first movable diaphragm. At least part of the first portion of the magnetic circuit assembly can be disposed forward of the first movable diaphragm. The transducer assembly can include a second active acoustic radiator supported by the frame. The second active acoustic radiator can include a second movable diaphragm. At least part of the second portion of the magnetic circuit assembly can be disposed forward of the second movable diaphragm. The first voice coil and the second voice coil can move toward each other and away from each other with the first active acoustic radiator and second active acoustic radiator driven with signals having a same electrical polarity.

In some variants, the first movable diaphragm and the second movable diaphragm can each include a cone shape. The first portion of the magnetic circuit assembly can be at least partially disposed in a void of the cone shape of the first movable diaphragm. The second portion of the magnetic circuit assembly can be at least partially disposed in a void of the cone shape of the second movable diaphragm.

In some variants, the transducer assembly can include a structural member disposed between the first active acoustic radiator and the second active acoustic radiator. The structural member can receive the first portion and/or the second portion of the magnetic circuit assembly.

In some variants, the transducer assembly can include a first structural member and a second structural member. The first structural member and the second structural member can be disposed between the first active acoustic radiator and the second active acoustic radiator. The first structural member can receive the first portion of the magnetic circuit assembly. The second structural member can receive the second portion of the magnetic circuit assembly.

In some variants, the magnetic circuit assembly can be disposed in a plenum space of the transducer assembly.

In some variants, the first voice coil and the second voice coil can be coaxially positioned.

A transducer assembly can include a frame. The frame can include an interior fluid volume or plenum. The transducer assembly can include a motor assembly. The motor assembly can include a first magnet, a first top plate, a second magnet, a second top plate, and/or a yoke forming two magnetic gaps. The transducer assembly can include a first active acoustic radiator disposed in the interior fluid volume or plenum. The first active acoustic radiator can include a first movable diaphragm, a first rear suspension, and/or a first voice coil. The first rear suspension and the first voice coil can be disposed on opposite sides of the first movable diaphragm. The transducer assembly can include a second active acoustic radiator disposed in the interior fluid volume or plenum. The second active acoustic radiator can include a second movable diaphragm, a second rear suspension, and/or a second voice coil. The second rear suspension and the second voice coil can be disposed on opposite sides of the second movable diaphragm. The first voice coil can be disposed within a first gap of the two magnetic gaps. The second voice coil can be disposed within a second gap of the two magnetic gaps. The first voice coil and the second voice coil can move toward each other and away from each other with the first active acoustic radiator and the second active acoustic radiator driven with signals having a same electrical polarity.

In some variants, the transducer assembly can include a structural member disposed between the first active acoustic radiator and the second active acoustic radiator. The structural member can receive the motor assembly.

In some variants, a first central axis of the first voice coil and a second central axis of the second voice coil can be coaxially positioned.

In some variants, a first central axis of the first voice coil and a second central axis of the second voice coil can be parallel.

In some variants, a first central axis of the first voice coil and a second central axis of the second voice coil can be angled relative to each other.

In some variants, the first movable diaphragm and the second movable diaphragm can each include a cone shape. The motor assembly can be at least partially disposed in a void of the cone shape of the first movable diaphragm and the second movable diaphragm.

In some variants, magnetic field directions in the two magnetic gaps can be in a same direction.

In some variants, magnetic field directions in the two magnetic gaps can be in opposite directions. The first voice coil and the second voice coil can move toward each other and away from each other with the first active acoustic radiator and the second active acoustic radiator driven with signals having opposite electrical polarity if the magnetic field directions in the magnetic gaps are in opposite directions.

In some variants, the first active acoustic radiator and the second active acoustic radiator can each include magnetic circuit components. One or more of the magnetic circuit components can include multiple parts.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure. Certain elements may be omitted from these images for clarity, or because they are not necessary to depicting the functional parts of an embodiment.

FIG. 1 illustrates a schematic view of a dual-opposed inverted transducer assembly viewed from the front and inscribed within an ellipse.

FIG. 2A illustrates a schematic view of the dual-opposed inverted transducer assembly with arrows representing motor assembly components driving towards each other and directions of air movement.

FIG. 2B illustrates a schematic view of the dual-opposed inverted transducer assembly with arrows representing motor assembly components driving away from each other and directions of air movement.

FIG. 3A illustrates the effective piston areas of the active acoustic radiators of the dual-opposed transducer assembly.

FIG. 3B illustrates the effective piston area of a conventional active acoustic radiator.

FIG. 4A illustrates a front perspective view of a dual-opposed inverted transducer assembly.

FIG. 4B illustrates a rear perspective view of the dual-opposed inverted transducer assembly of FIG. 4A.

FIG. 4C illustrates a sectioned rear view of the dual-opposed inverted transducer assembly of FIG. 4A.

FIG. 4D illustrates a sectioned side view of the dual-opposed inverted transducer assembly of FIG. 4A.

FIG. 4E illustrates a sectioned front-perspective view of the dual-opposed inverted transducer assembly of FIG. 4A.

FIG. 4F illustrates a sectioned rear-perspective view of the dual-opposed inverted transducer assembly of FIG. 4A.

### DETAILED DESCRIPTION OF THE PREFERRED EMBODIMENT

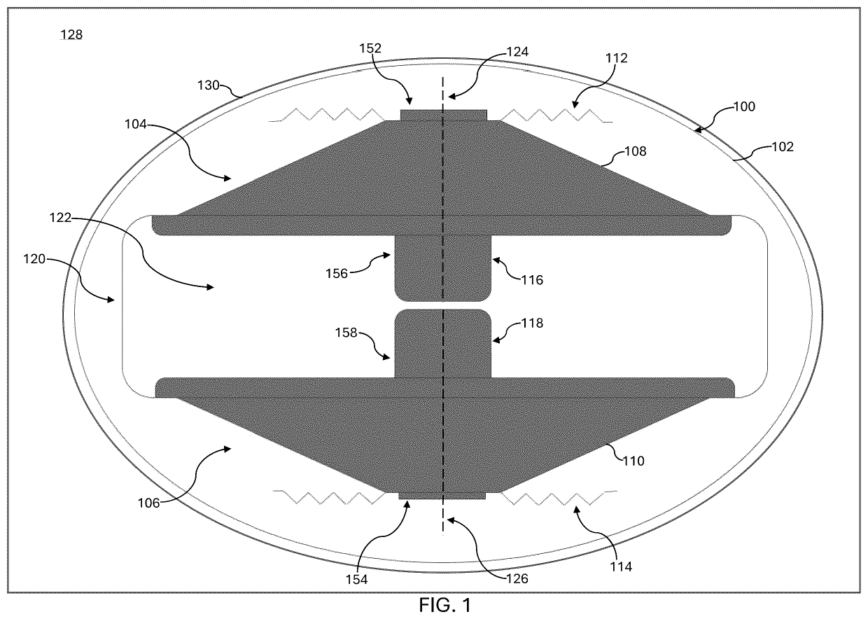

FIG. 1 illustrates a transducer assembly 100, which can also be referred to as a dual-opposed inverted transducer. The transducer assembly 100 can be disposed in a variety of locations, which can at least include an interior trim 128 (e.g., mounting substrate) of a vehicle (e.g., interior trim of a door, interior trim of a dashboard, etc.). The vehicle can at least be an automobile (e.g., car, truck, recreational vehicle, van, motorcycle, bus, etc.), aircraft (e.g., plane, helicopter, etc.), watercraft (e.g., boat, powerboat, sailboat, ship, jetski, etc.), train, machine (e.g., equipment, construction equipment), etc. Alternately, the transducer assembly may be installed in the wall, floor, or ceiling of a dwelling, in a bracket designed to receive the transducer assembly, or in an open or closed pressure vessel enclosure configured to receive the transducer assembly. The enclosure may include other forms of acoustic loading (e.g. vented, passive radiator, transmission line, acoustic waveguide, acoustic horn, etc.) The transducer assembly 100 can include features to reduce BSR issues and/or efficiently use space for improved performance. The transducer assembly 100 can replace a conventional transducer assembly with an acoustic radiator, which can include replacing the conventional transducer assembly mounted to an interior trim 128 of a vehicle.

The transducer assembly 100 can include a first active acoustic radiator 104 and a second active acoustic radiator 106. The first active acoustic radiator 104 and second active acoustic radiator 106 can oppose (e.g., face) each other. The first active acoustic radiator 104 can include a first movable diaphragm 108. The second active acoustic radiator 106 can include a second movable diaphragm 110. The first movable diaphragm 108 and/or second movable diaphragm 110 can be configured as a cone with a void, flat piston, or other mechanically stable shape to distribute voice coil force over a radiating surface area (Sd). The combined surface area of the first movable diaphragm 108 and/or second movable diaphragm 110 may sum to a surface area similar or equal to that of a diaphragm of a conventional transducer assembly being replaced by the transducer assembly 100, which can provide similar air movement vs. excursion. The movable diaphragm may be provided with a movable seal disposed at an edge of the diaphragm away from the center, to prevent air escaping past the moving diaphragm and a surrounding structure or duct.

The first active acoustic radiator 104 can include a first rear suspension 112 (e.g., spider). The first rear suspension 112 can be disposed at a rear side of the first movable diaphragm 108. The second active acoustic radiator 106 can include a second rear suspension 114 (e.g., spider). The second rear suspension 114 can be disposed at a rear side of the second movable diaphragm 110.

The first active acoustic radiator 104 can include a first motor assembly 116. The second active acoustic radiator 106 can include a second motor assembly 118. The first motor assembly 116 and second motor assembly 118 can each include a fixed and/or permanent magnet (e.g., ceramic or rare earth magnet), ferromagnetic components (e.g., yoke with pole piece, plates, steel components, etc.) to conduct magnetic flux to an air gap, a voice coil, and/or a former element. For example, the first motor assembly 116 can include a first yoke 152. The second motor assembly 118 can include a second yoke 154. The first motor assembly 116 can include a first pole piece 156, which can be part of the first yoke 152. The second motor assembly 118 can include a second pole piece 158, which can be part of the second yoke 154. The voice coils can be wound on the former elements which can be disposed about the first pole piece 156 and second pole piece 158 and partially immersed in a magnetic field. The former element carrying each voice coil may be free to move in response to an electrical signal applied to the coil. The former element can be hollow. The pole pieces and/or former element can have peripheries with a variety of shapes, which can at least include round, elliptical, obround, and/or rectangular.

The first motor assembly 116 and the second motor assembly 118 can be centralized. In some embodiments, the two motor assemblies may be in contact; in others, they may be separated by a gap, or by other material. The first motor assembly 116 can be disposed on a front side of the first movable diaphragm 108, which can include being disposed in a void of the first movable diaphragm 108 and/or on a side of the first movable diaphragm 108 opposite the first rear suspension 112. The second motor assembly 118 can be disposed on a front side of the second movable diaphragm 110, which can include being disposed in a void of the second movable diaphragm 110 and/or on a side of the second movable diaphragm 110 opposite the second rear suspension 114. The first motor assembly 116 can be disposed between the first movable diaphragm 108 and the second movable diaphragm 110. The second motor assembly 118 can be disposed between the first movable diaphragm 108 and the second movable diaphragm 110. The first active acoustic radiator 104 can include a first axis 124. The first axis 124 can be a central axis of the first active acoustic radiator 104, first motor assembly 116, voice coil of the first motor assembly 116, and/or former element of the first motor assembly 116. The second active acoustic radiator 106 can include a second axis 126. The second axis 126 can be a central axis of the second active acoustic radiator 106, second motor assembly 118, voice coil of the second motor assembly 118, and/or former element of the second motor assembly 118. In some variants, the first axis 124 and second axis 126 can be coaxially positioned and/or parallel relative to each other. In some variants, the first axis 124 and second axis 126 can be oriented at an angle relative to each other such that the resultant reaction force in a normal direction is reduced while the transducer assembly 100 is driving. As the first motor assembly 116 and second motor assembly 118 drive towards each other and away from each other, a resultant reaction force about an axial center of the transducer assembly 100 can be reduced. The axial center, as illustrated in FIG. 1, can be an axis that is coaxial with the first axis 124 and second axis 126.

The transducer assembly 100 can include a front structural member 120 (e.g., front suspension component) that can couple the first active acoustic radiator 104 and second active acoustic radiator 106. In some variants, each of the first active acoustic radiator 104 and the second active acoustic radiator 106 can include a front suspension member (e.g., front suspension component), which can be separate or coupled together.

The transducer assembly 100 can include a slot 122 disposed between the first active acoustic radiator 104 and second active acoustic radiator 106 through which airflow and acoustic output from the first active acoustic radiator 104 and/or second active acoustic radiator 106 can flow. In some variants, the transducer assembly 100 can include or be coupled to a manifold to direct sound to multiple locations. The first motor assembly 116 and second motor assembly 118 can be disposed in the slot 122. The slot can have additional geometry intended to smooth the bi-directional airflow produced during operation, or to reduce acoustical resonances within the slot.

The transducer assembly 100, in some variants, can include a frame 102. The first active acoustic radiator 104 and second active acoustic radiator 106 can be disposed (e.g., mounted) within the frame 102, which can include being coupled to the frame 102. The frame 102 can have a shape and/or size to fit within a region 130 (e.g., opening, cavity, mounting location, envelope, packaging envelope, etc.) of the interior trim 128. The transducer assembly 100 can be coupled to the interior trim 128 as an assembled unit with the frame 102. In some variants, the first active acoustic radiator 104 and second active acoustic radiator 106 can be integral with the frame 102. In some variants, the first active acoustic radiator 104 can be disposed in a first frame and the second active acoustic radiator 106 can be disposed in a second frame. The first frame and second frame can be shaped and/or sized to fit within the region 130. The first active acoustic radiator 104 and/or second active acoustic radiator 106 can be disposed in a plenum space of the frame 102. In some variants, the frame 102 can include an enclosed air volume (e.g., speaker enclosure, such as a sealed, ported, and/or passive radiator enclosure type) that can be separate from air volumes on either side of a mounting wall (e.g., interior trim 128). In some variants, the frame 102 can include an interior fluid volume or plenum. The first active acoustic radiator 104 and/or second active acoustic radiator 106 can be disposed in the interior fluid volume or plenum.

In some variants, the first motor assembly 116 and second motor assembly 118 can be coupled together and/or restrained within a structure. In some variants, a structural member (e.g., frame, support) can be disposed between the first active acoustic radiator 104 and the second active acoustic radiator 106 that couples the first motor assembly 116 and second motor assembly 118 together. For example, the structural member can couple together the pole pieces of the first motor assembly 116 and the second motor assembly 118.

The first active acoustic radiator 104 and second active acoustic radiator 106 can include a shape and/or size to enable compact packaging within the dimensions of a region 130 of the interior trim 128 for a conventional speaker. A conventional speaker can be oriented to produce a reaction force normal to a mounting surface of the region 130 while the first active acoustic radiator 104 and second active acoustic radiator 106 of the transducer assembly 100 can be oriented to produce reaction forces parallel to the mounting surface of the region 130. The arrangement of the first active acoustic radiator 104 and second active acoustic radiator 106 can be such that the components thereof fit within a packaging envelope having the overall depth, width, and/or length of a standard elliptical or round speaker shape assembly such that the transducer assembly 100 can be installed in the same region 130 (e.g., opening) as a conventional speaker.

The first motor assembly 116 and second motor assembly 118 can be driven with signals having the same electrical polarity. The first motor assembly 116 and second motor assembly 118 can produce acoustic output proportional to the electrical signal input. The moveable components (e.g., formers, voice coils, and/or diaphragms) of the first active acoustic radiator 104 and second active acoustic radiator 106 can move toward each other and away from each other as the first motor assembly 116 and second motor assembly 118 drive which can produce reaction forces in opposite directions relative to the direction of movement such that the reaction forces are balanced (e.g., reduced or eliminated).

In some variants, the active acoustic radiators of the transducer assembly 100 (e.g., the first active acoustic radiator 104 and second active acoustic radiator 106) can operate in an infinite baffle configuration. In some variants, one or both of the first active acoustic radiator 104 and second active acoustic radiator 106 can be loaded by an enclosure providing a defined volume and acoustic loading (e.g., sealed, reflex, etc.).

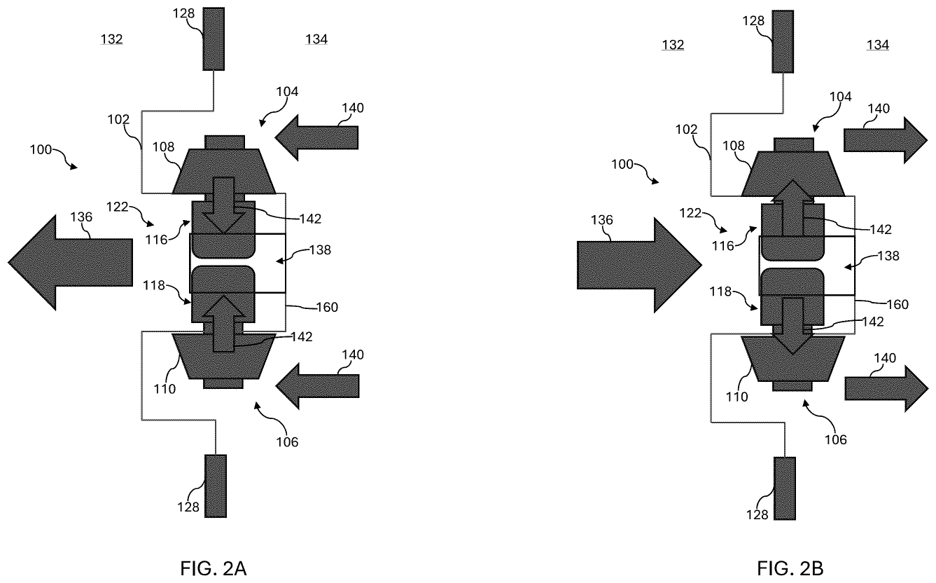

FIG. 2A illustrates the transducer assembly 100 with arrows representing movable motor assembly components (e.g., diaphragms, voice coils, formers) driving towards each other and corresponding directions of air movement. As the moveable motor assembly components move toward each other as represented by arrows 142, airflow is produced out of the slot 122 (e.g., plenum of air space) as represented by arrow 136. The first active acoustic radiator 104 and second active acoustic radiator 106 can move air in the direction of arrows 140 from a second air space 134, which can be disposed within an interior trim 128 of a vehicle, to and out of the slot 122 as indicated by arrow 136 into a first air space 132. As discussed herein, movement of the movable components of the first active acoustic radiator 104 and second active acoustic radiator 106 toward each other can create reaction forces, but with movement in opposite directions, those reaction forces can be balanced (e.g., reduced or eliminated). The first active acoustic radiator 104 and second active acoustic radiator 106 can, in some variants, be coupled to the frame 102 to transmit forces between the first active acoustic radiator 104 and second active acoustic radiator 106 through the frame 102 to balance the reaction forces resulting from movement. In some variants, a structural member 138 (e.g., frame, support, etc.) can be disposed between the first active acoustic radiator 104 and second active acoustic radiator 106 to couple (e.g., receive) the first motor assembly 116 and second motor assembly 118 (e.g., pole pieces) together. The reaction forces along a common axis of the first active acoustic radiator 104 and second active acoustic radiator 106 can be borne by the structural member 138. The structural member 138 can facilitate improved transmission of forces between the first motor assembly 116 and second motor assembly 118 to balance reaction forces to reduce force transmission to the interior trim 128 which can reduce or eliminate BSR issues (e.g., vibration). The structural member 138 can be coupled to a surface 160. The surface 160 can be part of the frame 102 and/or interior trim 128 of the vehicle.

FIG. 2B illustrates the transducer assembly 100 with arrows representing movable motor assembly components (e.g., diaphragms, voice coils, formers) driving away from each other and corresponding directions of air movement. As the moveable motor assembly components move away from each other as represented by arrows 142, airflow is produced into the slot 122 (e.g., plenum of air space) as represented by arrow 136. The first active acoustic radiator 104 and second active acoustic radiator 106 can move air from the first air space 132 in the direction of arrow 136 into the slot 122 and to the second air space 134 as indicated by arrows 140. As discussed herein, movement of the movable components of the first active acoustic radiator 104 and second active acoustic radiator 106 away from each other can create reaction forces, but with movement in opposite directions, those reaction forces can be balanced (e.g., reduced or eliminated). The frame 102 and/or structural member 138 can assist in balancing those reaction forces.

In some variants, the first motor assembly 116 and second motor assembly 118 can be collectively referred to as a single, combined motor assembly with a magnetic circuit assembly. In some variants, the first motor assembly 116 can be referred to as a first portion of the magnetic circuit assembly. In some variants, the second motor assembly 118 can be referred to as a second portion of the magnetic assembly. The first portion and/or the second portion can include a fixed and/or permanent magnet (e.g., rare earth magnet), components (e.g., yoke with pole piece, plates, steel components, etc.) to conduct magnetic flux to an air gap, a voice coil, and/or a former element. The first portion and second portion can, in some variants, include a shared yoke, which can include at least two magnetic gaps (e.g., one magnetic gap for a first voice coil of the first portion and another magnetic gap for a second voice coil of the second portion). The magnetic circuit formed by these components may provide flux in a same direction or in opposite directions.

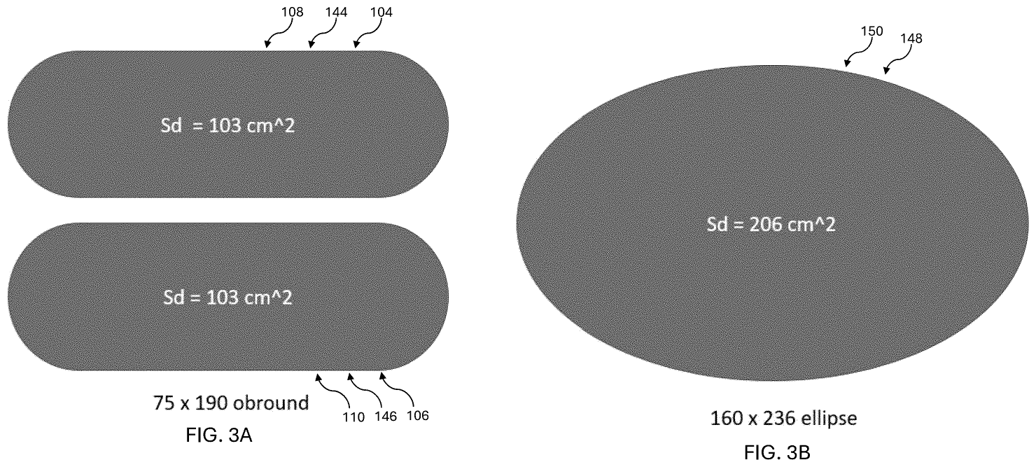

FIG. 3A illustrates a piston area 144 (e.g., Sd) of the first movable diaphragm 108 of the first active acoustic radiator 104 and a piston area 146 (e.g., Sd) of the second movable diaphragm 110 of the second active acoustic radiator 106. The shapes (e.g., circle, ellipse, obround, rectangular, etc.) and/or sizes of the piston area 144 and piston area 146 can be the same. As detailed herein, the combined piston area (e.g., Sd) of the piston area 144 and piston area 146 can be the same as or similar to the piston area 150 of a moveable diaphragm 162 of a conventional active acoustic radiator 148, which can be an elliptical shape as illustrated in FIG. 3B, being replaced by the transducer assembly 100. The inverted topography of the first active acoustic radiator 104 and second active acoustic radiator 106 can efficiently use space such that the combined piston area of the piston area 144 and piston area 146 is the same as or similar to the piston area 150 of a conventional active acoustic radiator 148 being replaced by the transducer assembly 100 while still allowing the transducer assembly 100 to fit within the same size packaging envelope as the conventional active acoustic radiator 148. Accordingly, the swept air volume of the first active acoustic radiator 104 and second active acoustic radiator 106 can be equal or similar to that of the conventional active acoustic radiator 148 being replaced with the same amount of linear piston travel. As an example, the piston area 144 and piston area 146 can each be 103 cm², and the combined piston area 150 can be 206 cm², a similar value to a commonly used elliptical speaker size. This can allow the assembly of opposing transducers to directly replace a commonly used elliptical speaker having the same amount of linear voice coil travel, and so displacing the same volume of air. The outside dimension of the surround rolls for each of the first active acoustic radiator 104 and second active acoustic radiator 106 can be 75 millimeters by 190 millimeters. The outside dimension of the surround roll for the conventional active acoustic radiator 148 can be 160 millimeters by 236 millimeters.

In some variants, the first active acoustic radiator 104 and/or second active acoustic radiator 106 can be physically conjoined at a rear surface such that the first active acoustic radiator 104 and second active acoustic radiator 106 face away from each other. For example, the first active acoustic radiator 104 and second active acoustic radiator 106 can include a motor assembly with a first magnet, a first top plate, a second magnet, a second top plate, and a yoke with two magnetic gaps. The magnets can be magnetized in opposing directions, which may involve assembly with pre-magnetized magnets. The magnets can be magnetized in the same direction, which can allow for magnetization after assembly. In some variants, the first yoke 152 and second yoke 154 can be coupled together. In some variants, the first yoke 152 and second yoke 154 can be portions (e.g., components) of a yoke. The voice coils of the first active acoustic radiator 104 and second active acoustic radiator 106 can be disposed within separate gaps of the yoke and configured to move toward each other and away from each other with the first active acoustic radiator 104 and second active acoustic radiator 106 driven with signals having the same electrical polarity. The magnetic field direction in the separate magnetic gaps can be in the same direction or opposite directions.

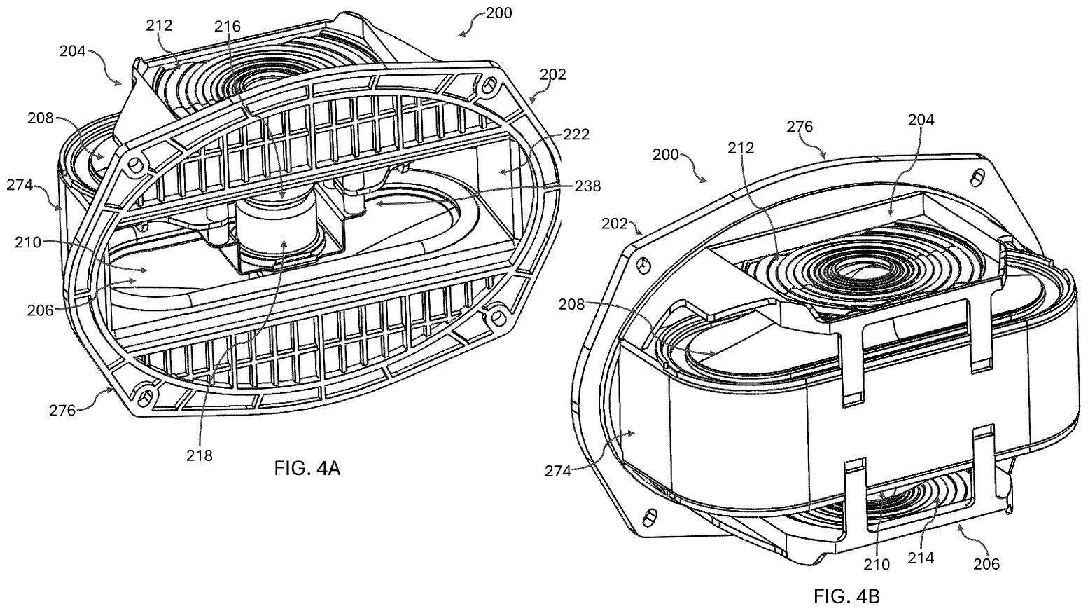

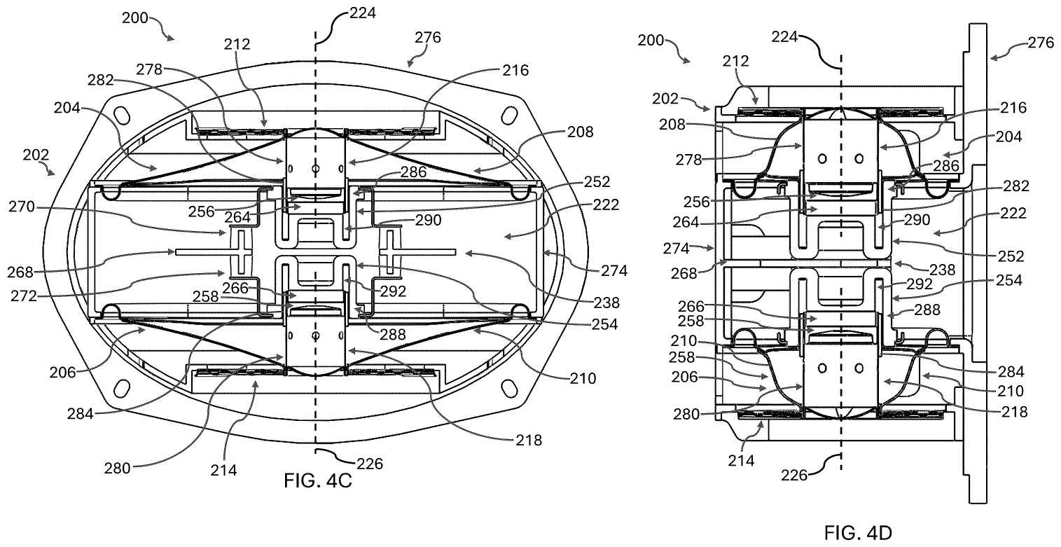

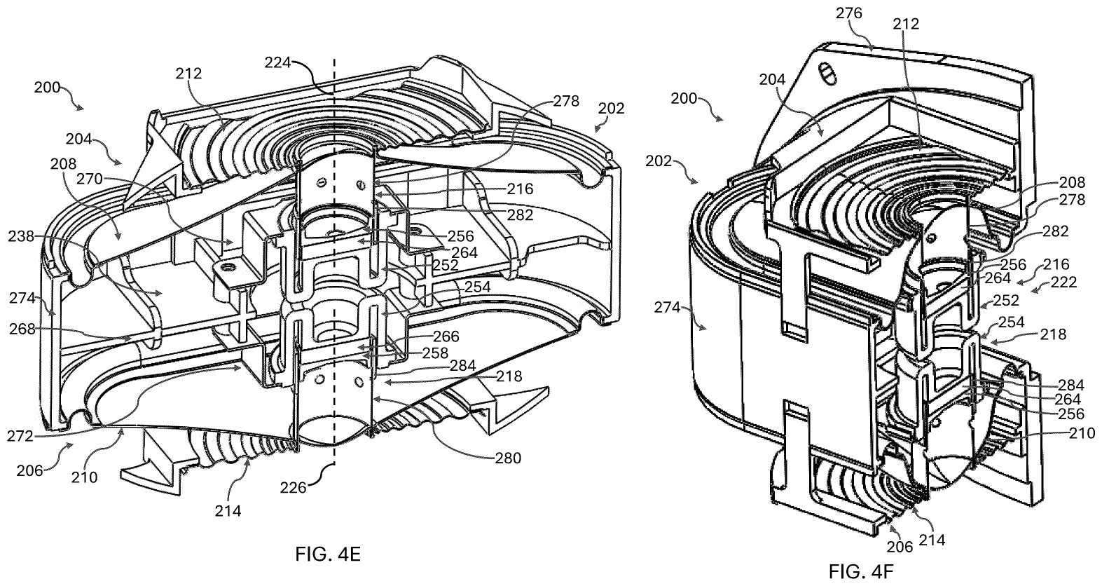

FIGS. 4A and 4B illustrate front and rear perspective views of a transducer assembly 200, which can also be referred to as a dual-opposed inverted transducer. The transducer assembly 200 can at least include any of the features shown and/or described in reference to transducer assembly 100.

The transducer assembly 200 can include a first active acoustic radiator 204 and a second active acoustic radiator 206. The first active acoustic radiator 204 and second active acoustic radiator 206 can oppose (e.g., face) each other. The first active acoustic radiator 204 can include a first movable diaphragm 208. The second active acoustic radiator 206 can include a second movable diaphragm 210. The first movable diaphragm 208 and/or second movable diaphragm 210 can be configured as cones with a void, flat piston, or other mechanically stable shape to distribute voice coil force over a radiating surface area (Sd). The combined surface area of the first movable diaphragm 208 and/or second movable diaphragm 210 may sum to a surface area similar or equal to that of a diaphragm of a conventional transducer assembly being replaced by the transducer assembly 200, which can provide similar air movement vs. excursion. The first movable diaphragm 208 and/or second movable diaphragm 210 may be provided with a movable seal disposed at an edge of the diaphragms away from the center, to prevent air escaping past the moving diaphragm and a surrounding structure or duct. The movable seal can have the shape of a surround roll or other flexible shape and can be made of flexible material to permit movement.

The first active acoustic radiator 204 can include a first motor assembly 216 and a first rear suspension 212. The topography of the first active acoustic radiator 204 can be inverted such that the first motor assembly 216 and first rear suspension 212 are disposed on opposite sides of the first movable diaphragm 208. The first motor assembly 216 can be disposed at least partially in a void of the first movable diaphragm 208

The second active acoustic radiator 206 can include a second motor assembly 218 and a second rear suspension 214. The topography of the second active acoustic radiator 206 can be inverted such that the second motor assembly 218 and the second rear suspension 214 are disposed on opposite sides of the second movable diaphragm 210. The second motor assembly 218 can be disposed at least partially in a void of the second movable diaphragm 210. The first motor assembly 216 and second motor assembly 218 can be disposed between the first movable diaphragm 208 and second movable diaphragm 210.

As the first motor assembly 216 and second motor assembly 218 drive towards each other and away from each other from an electrical input, a resultant reaction force about an axial center of the transducer assembly 200 can be balanced (e.g., reduced or eliminated). The transducer assembly 200 can include a frame 202. The first active acoustic radiator 204 and second active acoustic radiator 206 can be coupled to the frame 202 to facilitate the transmission of forces between the first active acoustic radiator 204 and second active acoustic radiator 206 to balance reaction forces resulting from movement.

In some variants, a structural member 238 (e.g., frame, support, etc.) can be disposed between the first active acoustic radiator 204 and second active acoustic radiator 206 to couple (e.g., receive) the first motor assembly 216 and second motor assembly 218 (e.g., yokes) together. The reaction forces along a common axis of the first active acoustic radiator 204 and second active acoustic radiator 206 can be borne by the structural member 238. The structural member 238 can facilitate improved transmission of forces between the first motor assembly 216 and second motor assembly 218 to balance reaction forces, which can reduce force transmission to an interior trim of a vehicle to reduce or eliminate BSR issues (e.g., vibration). The structural member 238 can be coupled to the frame 202, which can include being coupled to a peripheral wall 274 of the frame 202. The frame 202 can include reinforcing structural features.

In some variants, the transducer assembly 200 can include a mounting flange 276. The mounting flange 276 can be used to mount the transducer assembly 200 in a variety of environments, which can at least include any of those described herein.

The transducer assembly 200 can include a slot 222. The slot 222 can be disposed between the first movable diaphragm 208 and second movable diaphragm 210. Air can be moved in and out from between the first movable diaphragm 208 and second movable diaphragm 210 through the slot 222 with the first motor assembly 216 and second motor assembly 218 driving to produce sound. In some embodiments, the slot can be connected to a duct or other acoustical path for sound transmission. In some embodiments, the slot may be connected to multiple exit areas.

FIGS. 4C-4F illustrates sectioned views of the transducer assembly 200. As illustrated, the first motor assembly 216 can include a first voice coil 282 disposed about a first former 278, a first magnet 264, a first pole piece 256, and/or a first yoke 252, which can be referred to as a u-yoke, shellpot, and/or shellpot yoke. The first former 278 can be disposed about the first pole piece 256, first magnet 264, and/or a portion (e.g., central portion) of the first yoke 252. The first voice coil 282, first former 278, first pole piece 256, first magnet 264, and/or first yoke 252 can be centered about a first axis 224 of the first active acoustic radiator 204.

The first pole piece 256 can be coupled (e.g., bonded) to the first magnet 264. The first pole piece 256 can include an internal recess, which can include an internally beveled core out geometry. The first magnet 264 can be couped to first yoke 252. The first magnet 264 can be axially disposed between the first pole piece 256 and the first yoke 252. The first yoke 252 can include a first annular gap 290 that can receive the first former 278 and/or first voice coil 282 with the first motor assembly 216 driving. The first yoke 252 can include a first peripheral wall 286, which can include an annular shape. The first peripheral wall 286 can be disposed radially about the first magnet 264, first pole piece 256, first voice coil 282, and/or first former 278. A magnetic gap can be radially disposed between the first pole piece 256 and the first peripheral wall 286 of the first yoke 252. The first voice coil 282 can be disposed in the magnetic gap.

The first yoke 252 (e.g., first peripheral wall 286) can be coupled to the structural member 238. For example, the structural member 238 can include a horizontal flange 268 that can be coupled to the frame 202 (e.g., peripheral wall 274). The horizontal flange 268 can extend radially inward from the peripheral wall 274 toward the first axis 224. The horizontal flange 268 can include reinforcing structural features, which can include vertically oriented flanges that can be coupled to the peripheral wall 274. The structural member 238 can include a first mount portion 270 that is coupled to the first yoke 252 (e.g., first peripheral wall 286). The first mount portion 270 can be coupled to the horizontal flange 268. The structural member 238 can provide structural support to the first yoke 252.

As illustrated, the second motor assembly 218 can include a second voice coil 284 disposed about a second former 280, a second magnet 266, a second pole piece 258, and/or a second yoke 254, which can be referred to as a u-yoke, shellpot, and/or shellpot yoke. The second former 280 can be disposed about the second pole piece 258, second magnet 266, and/or a portion (e.g., central portion) of the second yoke 254. The second voice coil 284, second former 280, second pole piece 258, second magnet 266, and/or second yoke 254 can be centered about a second axis 226 of the second active acoustic radiator 206.

The second pole piece 258 can be coupled (e.g., bonded) to the second magnet 266. The second pole piece 258 can include an internal recess, which can include an internally beveled core out geometry. The second magnet 266 can be couped to second yoke 254. The second magnet 266 can be axially disposed between the second pole piece 258 and the second yoke 254. The second yoke 254 can include a second annular gap 292 that can receive the second former 280 and/or second voice coil 284 with the second motor assembly 218 driving. The second yoke 254 can include a second peripheral wall 288, which can include an annular shape. The second peripheral wall 288 can be disposed about the second magnet 266, second pole piece 258, second voice coil 284, and/or second former 280. A magnetic gap can be radially disposed between the second pole piece 258 and the second peripheral wall 288 of the second yoke 254. The second voice coil 284 can be disposed in the magnetic gap.

The second yoke 254 (e.g., second peripheral wall 288) can be coupled to the structural member 238. For example, the structural member 238 can include a second mount portion 272 that is coupled to the second yoke 254 (e.g., second peripheral wall 288). The second mount portion 272 can be coupled to the horizontal flange 268. The second mount portion 272 can be disposed on an opposite side of the horizontal flange 268 relative to the first mount portion 270. The first mount portion 270 and second mount portion 272 can be disposed in a mirrored arrangement relative to each other about the horizontal flange 268. The structural member 238 can provide structural support to the second yoke 254.

In use, the first former 278 and second former 280 (e.g., tubular members) with the first and second voice coils 282, 284 can move toward each other and away from each other with an electrical current applied to the first and second voice coils 282, 284. For example, the first and second voice coil 282, 284 can be disposed within magnetic gaps (e.g., within a magnet's magnetic field). An electrical signal, such as an audio signal, can flow through the first and second voice coils 282, 284 to provide varying magnetic fields around the first and second voice coils 282, 284 from the interaction between the electrical signal (e.g., current) and the magnetic fields. The interactions between the magnetic fields of the first and second voice coils 282, 284 and the permanent magnets' fields can cause the first and second voice coils 282, 284 and first and second formers 278, 280 to move toward each other and away from each other. The direction of current can change the direction of the movement. The first and second diaphragms 208, 210 (e.g., cones) can be respectively attached to the first and second formers 278, 280 and/or the first and second voice coils 282, 284. As the formers 278, 280 and voice coils 282, 284 move, the first and second diaphragms 208, 210 can move as well to create pressure waves in the air, which an ear and/or microphone can perceive as sound. The frequency and/or amplitude of the electrical signal can determine the pitch and/or volume of the sound produced.

The reaction forces along a common axis of the first active acoustic radiator 204 and second active acoustic radiator 206 can be borne by the structural member 238. The structural member 238 can facilitate improved transmission of forces between the first motor assembly 216 and second motor assembly 218 to balance reaction forces to reduce force transmission to an interior trim of a vehicle which can reduce or eliminate BSR issues (e.g., vibration). The structural member 238 can be coupled to a surface. The surface can be part of the frame and/or interior trim of a vehicle.

In some variants, the first axis 224 and second axis 226 can be coaxially positioned and/or parallel relative to each other. In some variants, the first axis 224 and second axis 226 can be oriented at an angle relative to each other such that the resultant reaction force in a normal direction is reduced while the transducer assembly 200 is driving. As the first motor assembly 216 and second motor assembly 218 drive towards each other and away from each other, a resultant reaction force about an axial center of the transducer assembly 200 can be reduced. The axial center of the transducer assembly 200, as illustrated, can be an axis that is coaxial with the first axis 224 and second axis 226.

As illustrated, perimeter(s) of the first movable diaphragm 208 and/or second movable diaphragm 210 can be sealed, which can include the implementation of moveable seal(s), to impede air escaping past the first movable diaphragm 208, second movable diaphragm 210, and/or a surrounding structure.

Magnetic circuit can refer to a magnet, pole piece, yoke, voice coil, magnetic gap, plates, and/or other features used to cause a voice coil to move a diaphragm in response to an electrical signal.

It is intended that the scope of this present invention herein disclosed should not be limited by the particular disclosed embodiments described above. For example, the transducer assemblies are described, in some instances, within the context of an interior trim of a vehicle; however, the transducer assemblies described herein can be utilized in other contexts. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the assemblies and constituent parts described herein can be combined to form further embodiments, which are part of this disclosure. An assembly of transducers can refer, in some instances, to a group of multiple transducers and a supporting structure.

Methods of using the described embodiments (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and variants of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and variants of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “mounting a transducer onto a bracket” includes “instructing the mounting of a transducer onto a bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount. Where specific dimensions are disclosed, they are intended only as design examples, and are not meant to exclude or preclude the use of components of differing size performing the same basic function in the context of the embodiments here described.

What is claimed is:

1. A transducer assembly for a vehicle, the transducer assembly comprising:
a frame configured to be incorporated into an interior trim of a vehicle;
a first active acoustic radiator disposed in the frame, the first active acoustic radiator comprising a first movable diaphragm, a first rear suspension, and a first motor assembly comprising a first magnetic circuit and a first voice coil, wherein the first motor assembly is disposed at a front side of the first movable diaphragm and the first rear suspension is disposed at an opposite rear side of the first movable diaphragm;
a second active acoustic radiator disposed in the frame, the second active acoustic radiator comprising a second movable diaphragm, a second rear suspension, and a second motor assembly comprising a second magnetic circuit and a second voice coil, wherein the second motor assembly is disposed at a front side of the second movable diaphragm and the second rear suspension is disposed at an opposite rear side of the second movable diaphragm; and
a structural member disposed between the first active acoustic radiator and the second active acoustic radiator, the structural member configured to receive the first motor assembly and the second motor assembly;
wherein the first motor assembly and the second motor assembly are disposed between the first movable diaphragm and the second movable diaphragm; and
wherein the first voice coil and the second voice coil are configured to move toward each other and away from each other with the first active acoustic radiator and the second active acoustic radiator driven with signals having a same electrical polarity such that a resultant reaction force is reduced about an axial center.

2. The transducer assembly of claim 1, further comprising a front structural member connected to and extending between the first active acoustic radiator and the second active acoustic radiator.

3. The transducer assembly of claim 1, wherein the structural member is configured to couple the first motor assembly and the second motor assembly.

4. The transducer assembly of claim 1, wherein the first motor assembly and the second motor assembly are coaxially positioned.

5. The transducer assembly of claim 1, wherein the first movable diaphragm and the second movable diaphragm each comprise a cone shape, and wherein the first motor assembly is at least partially disposed in a void of the cone shape of the first movable diaphragm and the second motor assembly is at least partially disposed in a void of the cone shape of the second movable diaphragm.

6. The transducer assembly of claim 1, wherein the frame comprises an enclosed air volume.

7. The transducer assembly of claim 1, wherein the structural member is coupled to a wall of the vehicle.

8. A transducer assembly comprising:
a frame comprising an interior fluid volume or plenum;
a first active acoustic radiator disposed in the interior fluid volume or plenum, the first active acoustic radiator comprising a first movable diaphragm, a first rear suspension, and a first motor assembly, the first motor assembly comprising a first magnetic circuit and a first voice coil, wherein the first rear suspension and the first motor assembly are disposed on opposite sides of the first movable diaphragm; and
a second active acoustic radiator disposed in the interior fluid volume or plenum, the second active acoustic radiator comprising a second movable diaphragm, a second rear suspension, and a second motor assembly, the second motor assembly comprising a second magnetic circuit and a second voice coil, wherein the second rear suspension and the second motor assembly are disposed on opposite sides of the second movable diaphragm;
wherein the first voice coil and the second voice coil are configured to move toward each other and away from each other with the first active acoustic radiator and the second active acoustic radiator driven with signals having a same electrical polarity.

9. The transducer assembly of claim 8, further comprising a structural member disposed between the first active acoustic radiator and the second active acoustic radiator, the structural member configured to receive the first motor assembly and the second motor assembly.

10. The transducer assembly of claim 8, further comprising a first structural member and a second structural member, the first structural member and the second structural member disposed between the first active acoustic radiator and the second active acoustic radiator, wherein the first structural member receives the first motor assembly and the second structural member receives the second motor assembly.

11. The transducer assembly of claim 8, wherein a first central axis of the first motor assembly and a second central axis of the second motor assembly are coaxially positioned.

12. The transducer assembly of claim 8, wherein a first central axis of the first motor assembly and a second central axis of the second motor assembly are parallel.

13. The transducer assembly of claim 8, wherein a first central axis of the first motor assembly and a second central axis of the second motor assembly are angled relative to each other.

14. The transducer assembly of claim 8, wherein the first movable diaphragm and the second movable diaphragm each comprise a cone shape, and wherein the first motor assembly is at least partially disposed in a void of the cone shape of the first movable diaphragm and the second motor assembly is at least partially disposed in a void of the cone shape of the second movable diaphragm.

15. A transducer assembly comprising:
a frame;
a motor assembly comprising a magnetic circuit assembly, the magnetic circuit assembly comprising a first portion with a first voice coil and a second portion with a second voice coil;
a first active acoustic radiator supported by the frame, the first active acoustic radiator comprising a first movable diaphragm, wherein at least part of the first portion of the magnetic circuit assembly is disposed forward of the first movable diaphragm; and
a second active acoustic radiator supported by the frame, the second active acoustic radiator comprising a second movable diaphragm, wherein at least part of the second portion of the magnetic circuit assembly is disposed forward of the second movable diaphragm;
wherein the first voice coil and the second voice coil are configured to move toward each other and away from each other with the first active acoustic radiator and second active acoustic radiator driven with signals having a same electrical polarity.

16. The transducer assembly of claim 15, wherein the first movable diaphragm and the second movable diaphragm each comprise a cone shape, and wherein the first portion of the magnetic circuit assembly is at least partially disposed in a void of the cone shape of the first movable diaphragm and the second portion of the magnetic circuit assembly is at least partially disposed in a void of the cone shape of the second movable diaphragm.

17. The transducer assembly of claim 15, further comprising a structural member disposed between the first active acoustic radiator and the second active acoustic radiator, the structural member configured to receive the first portion and the second portion of the magnetic circuit assembly.

18. The transducer assembly of claim 15, further comprising a first structural member and a second structural member, the first structural member and the second structural member disposed between the first active acoustic radiator and the second active acoustic radiator, wherein the first structural member receives the first portion of the magnetic circuit assembly and the second structural member receives the second portion of the magnetic circuit assembly.

19. The transducer assembly of claim 15, wherein the magnetic circuit assembly is disposed in a plenum space of the transducer assembly.

20. The transducer assembly of claim 15, wherein the first voice coil and the second voice coil are coaxially positioned.
